(19) United States
(12) Patent Application Publication
(10) Pub. No.: US 2004/0047976 A1
(43) Pub. Date: Mar. 11, 2004

(54) Granulation process

(76) Inventors: Anantha Subramony Narayan, Mumbai (IN); Amitava Pramanik, Mumbai (IN); Dattaram Prashant Shinde, Mumbai (IN)

Correspondence Address: UNILEVER, PATENT DEPARTMENT, 45 RIVER ROAD, EDGEWATER, NJ, 07020, US

(21) Appl. No.: 10/344,511

(22) PCT Filed: Jul. 4, 2001
(86) PCT No.: PCT/EP01/07690

(30) Foreign Application Priority Data
Aug. 14, 2000 (IN) 751/MUM/00

(51) Int. Cl. A23L 1/30

(52) U.S. Cl. 426/648

(57) ABSTRACT

The invention concerns granulated, free flowing, edible salt composition comprising: i) 20 to 99.9 by weight sodium chloride; (ii) 0.1 to 80% by weight potassium chloride; (iii) 0 to 10% by weight of a water soluble chloride or sulphate salt of calcium or magnesium or a mixture thereof; (iv) 0 to 10% by weight of a flavoring agent wherein the particle size of said alkali metal chlorides (i.e. NaCl and KCl) is less than 500?. and processes to make these products.

### TECHNICAL FIELD

The present invention relates to a synergistically granulated, free flowing edible salt composition having an equivalent saltiness as common salt.

### BACKGROUND AND PRIOR ART

Sodium Chloride or common salt is an ingredient generally used in cooking (e.g. approximately 5 million tons is the annual human consumption in India.) Salt is generally produced by solar evaporation or multiple effect industrial evaporation of sea water or sub soil brine or a combination of these two and refined by the process of hydro milling. The process of hydro milling consists of washing the raw salt with brine and milling the same later. The washed salt is centrifuged and dried generally in a fluid bed drier or vacuum drier to remove the moisture and obtain pure salt. During the process of milling and drying significant quantities of fine salt is formed which is a low value material and is commonly treated as waste material.

Due to various reasons it is preferred to reduce the intake of sodium chloride This could be achieved by reducing the sodium chloride content of common salt, however reducing this level in common salt negatively affects the taste of a food product wherein this common salt is applied In order to impart a proper taste to the food, in spite of reducing the sodium chloride content, other salts such as potassium chloride have been substituted partially in compositions. However, these compositions have a problem in that it is less salty accompanied by a bitter taste and that they are not free flowing. Incorporating other edible salts such as chlorides of calcium and magnesium only aggravates the problem, as the material becomes highly hygroscopic.

Iodine is one of the three most essential but normally deficient micro-nutrients and the easiest and most inexpensive method of delivery of the same through food was found to be iodization of common salt. Hence, iodization of salt often is a statutory requirement, which accounts e.g. for all edible salt manufactured in India. This requirement is mainly to control the iodine deficiency disorders. Salt is iodized by spraying potassium iodate solution on salt. The particle size of commercially available iodized salt is in the region of 500 microns and for crystal salt about 2 mm.

The commercially available common salt, although free flowing and refined, is made by a process during which large amounts of salt fines having particle size lower than 500 microns are formed, which fines so far are discarded, leading to wastage of material and relatively high cost of the salt.

We studied whether we could find ways to overcome this wastage of materials. As a results of this study we found that free flowing salt composition in granulated form can be produced from salt fines having particle size of even less than 500 microns. It was further found that such granulated salt still has a saltiness equivalent to common salt.

As the fines produced during the refinement of salt in its production process can be employed in the production of the synergistic formulation of the present invention, the material which otherwise would be discarded as waste, can be converted into a suitable value-added material. The salt fines are rich in iodine and hence meet the mandatory iodine level in the salt.

It is therefore the basic object of the present invention to provide synergistic, fortified, edible salt compositions having an equivalent saltiness as common salt in a granulated free flowing form and a process for making the same.

Accordingly, the present invention provides a granulated, free flowing, edible salt composition comprising:

i. 20 to 99.9 by weight sodium chloride

ii. 0.1 to 80% by weight potassium chloride

iii. 0 to 10% by weight of a water soluble chloride or sulphate salt of calcium or magnesium or a mixture thereof

iv. 0 to 10% by weight of a flavouring agent

wherein the particle size of said alkali metal chlorides (i.e. NaCl and KCl) is less than 500μ.

According to a preferred aspect, the present invention provides a granulated, free flowing, edible salt composition comprising sodium chloride and potassium chloride in a ratio of 100:1 to 1:4 and more preferably 10:1 to 1:1, wherein the particle size of the said alkali metal chlorides is less than 200μ and 0.5 to 5% by weight of a soluble chloride or sulphate salt of calcium or magnesium or a mixture thereof and optionally upto 10% by weight of a flavouring agent

It is also possible to incorporate flavours such as garlic, ginger, pepper or any other spice or herbal flavours during granulation and the stability and homogeneity of these flavours will be enhanced due to the granulated form of the product.

According to another aspect of the present invention the invention concerns a process of obtaining a granulated, free flowing, edible salt composition comprising:

i. mixing 20 to 99.9% by weight of sodium chloride and 0.1 to 80% by weight of potassium chloride wherein the particle size of the alkali metal chlorides is less than 500μ, 0 to 10% by weight of a water soluble chloride or sulphate salt of calcium or magnesium or a mixture thereof and 0 to 10% by weight of a flavouring agent in a mixer;

ii. adding 5 to 15% water by weight of the total composition;

iii. granulating the mass of step ii to size in the range of 500μ to 10,000μ.

According to a preferred aspect of the present invention there is provided a process of obtaining a granulated, free flowing, edible salt composition comprising:

i. mixing sodium chloride and potassium chloride in a ratio 100:1 to 1:4 and more preferably 10:1 to 1:1, wherein the particle size of the alkali metal chlorides is less than 200μ, 0.5 to 5% by weight of a water soluble chloride or sulphate salt of calcium or magnesium or a mixture thereof and 0 to 10% by weight of a flavouring agent in a mixer;

ii. adding 5 to 15% water by weight

iii. extruding the mass obtained in step (ii) to obtain noodles; and

iv. optionally subjecting the noodles to spherodisation and subsequent drying to bring the moisture to 1 to 7%.

Additionally, the salt produced according to the invention may be enriched further with a source of iodine selected from iodate or iodide salt of sodium, potassium or calcium. The source of iodine when incorporated is preferably added to the step (i) during mixing.

In the above process the spherodiser consists of a static cylindrical vessel with gas inlets to provide radial and axial mixing of the material and simultaneous drying with a rotating base plate that is flat or corrugated or checkered. When the plate is flat it is preferable to provide 2 to 6 numbers of baffles forming an angle of at least 5 degrees with the base plate.

### DETAILED DESCRIPTION OF THE INVENTION

The invention essentially comprises of processing a synergistic granulated, free flowing, edible salt comprising 20 to 99.9% by weight sodium chloride, 0.1 to 80% by weight potassium chloride and 0 to 10% by weight of a soluble chloride or sulphate salt of calcium or magnesium or a mixture thereof, and 0 to 10% of a flavouring agent, wherein the particle size of said alkali metal chlorides is less than 500μ

The chloride salt of the alkali metal refers to sodium or potassium chloride, which preferably are present in a ratio of sodium salt to potassium salt in the range of 100:1 to 1:4 and preferably 10:1 to 1:1.

It is especially preferred to incorporate a soluble chloride or sulphate salt of calcium or magnesium or a mixture thereof. It is particularly preferred to have these salts in a range from 0.5 to 5% by weight of the composition. It is more preferable to have the chloride salt of calcium or magnesium or a mixture of the two.

The mixing of the sodium chloride and potassium chloride wherein the particle size of the alkali metal chlorides is less than 500μ is generally done in a mixer that ensures uniform mixing and that can have any or a combination of agitator designs that include ribbon, sigma, plough share, helical, planetary or screw type mixer. Upto 10% by weight of a solution of water-soluble chloride or sulphate salt of calcium or magnesium or a mixture thereof is sprayed on to the mixture of the alkali metal chloride salts contained in the mixer. The flavouring agents are also incorporated preferably at this stage. The flavouring agent may be in the form of a powder or a liquid or a paste. The mixing is done at a temperature range of 5-50° C. The material is mixed for a period of 5 minutes to 120 minutes and preferably for 30-45 minutes to ensure homogeneity.

The water soluble chloride or sulphate salt of calcium or magnesium can be added as a powder along with the alkali metal salts and mixed in which case additionally 5-15% water is incorporated preferably using an atomiser to obtain a fine spray. Alternatively the soluble chloride or sulphate salt of calcium or magnesium can be dissolved in the 5-15% water and sprayed on to the alkali metal salt present in the mixer. Alternatively a combination of the two methods could be followed. It is preferable to continue mixing for a period of about 15 minutes after the water or the solution of the soluble salts is added.

The granulation of the mass can be done as a batch or continuous or semi-continuous process and is done using any suitable equipment known in the art which could be a pan granulator or drum granulator to obtain spherical particles in the size range 500 microns to 5,000μ and preferably 1,000 to 3,000μ. Alternately the salt mix could be extruded in a single or twin screw extruder or a die extruder with various configurations, to obtain noodles of 1,000μ to 3,000μ diameter and lengths of 500 to 5,000μ and preferably 1,500 to 2,500μ diameter and 1,500 to 3,000μ length. It is particularly preferred to use a die granulator. When the granulation is achieved by extrusion and the extruded form is noodle shaped, it can be dried and packed as such. Optionally the dried noodles can be gently degranulated to an irregular shape with a size in the range of 8 to 60 mesh and preferably in the range of 16 to 30 mesh and packed. Alternately, it is preferred to subject the noodles to a process that ensures sufficient force, pressure and attrition on the noodles that cause it to round off to spheres. This could be done in an equipment that provides the above in any or a combination of mechanical or pneumatic methods. An alternate process that is also preferred includes taking the wet salt mix from the mixer and granulating it using a tableting method to a diameter of 2,000 to 10,000μ, and preferably a diameter of 2,000 to 5,000μ.

The moisture level of the granules made by any of the methods above is maintained between 1-7% and preferably 4-6% and if necessary an additional drying step is included. The drying is done in any dryer known such as tray dryer, rotary dryer, vacuum dryer or a fluid bed dryer (batch, continuous or semi-continuous). Alternately the product could be air dried, sun dried or a combination of the two. The material is optionally sieved to obtain uniformity of product. The oversized and undersized particles could be further powdered and recycled with the feed. The granulated salt is suitable for selling either in packed form that may be in form of a polyethylene bag, paper pack, pet jars or any other suitable form or can be sold loose.

The granulated salt according to the invention can also be blended with common salt with a particle size of more than 500 micron or with crystal salt with a size of about 2 mm. Suitable weight ratios herefore are 0.1 to 99.9 to 99.9 to 0.1.

The invention is described in detail by the following non-limiting examples.

### EXAMPLES

### Process for Preparation of Granulated Salt

### Example 1

2 kg of edible salt powder with less than 200μ size was taken in a planetary mixer. The salt was then mixed with the desired amount of other metal salts like chloride of calcium and chloride of potassium in amounts equivalent to 1% and 10% of the mixture respectively. A part of the above mix (5%) was dissolved in water in an amount equivalent to 6% of the total mix. The above solution was added drop-wise to the salt mixture with agitation for half an hour. The wet salt mix was extruded into noodles using a die extruder of 1,000μ diameter. Some amount of dry mix of the above salts (amounting to 15% of the total weight of the salts) was co-extruded with the wet mix to prevent sticking of the noodles. The noodles were dried in a tray dryer at 90° C. for three hours and packed. The product was found to have very good salty taste and very good flow characteristics

### Example 2

Edible salt powder as in Example-1 was taken in a plough share mixer. The salt was then mixed with chloride of potassium used at 15% in the mixture. A part of the above mix (1%) and half this amount of chloride of magnesium was dissolved in water to an amount equivalent to 15% of the salt mix. All of the salt mix prepared was taken in a pan granulator kept at an angle of 40 degrees from the horizontal and rotating at 20 rpm. The salt solution prepared was sprayed on to the pan granulator using a hand held spray gun. The salt granules were formed in about 2 to 3 minutes. The pan was tilted and the material collected on to a tray. The tray was dried at 80° C. in a tray dryer for up to 4 hours to get the granules of the desired quality. The sample was sieved to the desired particle size (2-4 mm) and packed. Good taste and flow characteristics were observed with this sample prepared.

### Evaluation of the Salt

i. Saltiness:

A food preparation such as cooked lentil was prepared using 0.8% of the granulated salt prepared by the process described in Example 1 and 2 and was compared with a similar preparation using 0.8% commercially available salt or sodium chloride. A panel of trained members tasted the samples and evaluated the same for saltiness. The panel did not record any off taste and scored equally for both with regard to saltiness.

ii Flow properties:

The granulated salt was packed in a polyethylene bag under ambient condition (25° C.) and stored for three months at that temperature and 75% humidity. The initial dynamic flow rate of the samples at the end of every month for three months was measured using a flow meter. This was compared with commercially available powder salt where the flow properties are improved using flow aids.

TABLE 1

| | Commercial | | |
|---|---|---|---|
| | salt initial | Commercial salt | Salt |
| | sample | initial sample with | according |
| | without flow | 0.4% precipitated | to the |
| Sample | aid | silica as flow aid. | invention |
| | Dynamic flow rate (ml/sec) | | |
| Initial Sample | 105 | 160 | 180 |
| Stored for 1 | 100 | 155 | 178 |
| month | | | |
| Stored for 2 | 90 | 150 | 175 |
| month | | | |
| Stored for 3 | No flow | 140 | 170 |
| month | | | |

The data presented in Table 1 show that the granulated salt produced according the invention had excellent flow properties even in the absence of flow aids and had taste comparable to the commercially available salt. Thus the fines which actually form a waste material can be formed into an useful product.

1. Granulated, free flowing, edible salt composition comprising:
i 20 to 99.9 by weight sodium chloride
ii 0.1 to 80% by weight potassium chloride
iii 0.5 to 10% by weight of a water soluble chloride or sulphate salt of calcium or magnesium or a mixture thereof
iv 0 to 10% by weight of a flavouring agent
wherein the particle size of said alkali metal chlorides (i.e. NaCl and KCl) is less than 500μ.

2. Granulated free flowing edible salt according to claim 1 comprising sodium chloride and potassium chloride in a weight ratio of 100:1 to 1:4, preferably 10:1 to 1:1

3. Granulated free flowing edible salt according to claim 1 to 2 wherein the particle size of said alkali metal chloride in less than 200 μm.

4. Granulated free flowing edible salt according to claims 1 to 3 comprising also 0.5 to 5% by weight of a water soluble chloride or sulphate salt of calcium or magnesium or a mixture thereof

5. Granulated free flowing edible salt according to claims 1 to 4 also comprising as flavour garlic, ginger, pepper or any other spice or herbal flavours

6. Granulated free flowing edible salt according to claims 1 to 5 which granulated salts have a moisture level of 1 to 7 wt %

7. Blends comprising common salt with a particle size of more than 500 micron and/or crystal salt with a size of about 2 mm and the granulated salt according to claims 1 to 6 in weight ratios of 0.1 to 99.9 to 99.9 to 0.1

8. Process of obtaining a granulated, free flowing, edible salt composition comprising:
i mixing 20 to 99.9% by weight of sodium chloride and 0.1 to 80% by weight of potassium chloride wherein the particle size of the alkali metal chlorides is less than 500μ, 0.5 to 10% by weight of a water soluble chloride or sulphate salt of calcium or magnesium or a mixture thereof and 0 to 10% by weight of a flavouring agent in a mixer;
ii adding 5 to 15% water by weight of the total composition;
iii granulating the mass of step ii to size in the range of 500μ to 10,000μ.

9. Process of obtaining a granulated, free flowing, edible salt composition comprising:
i mixing sodium chloride and potassium chloride in a ratio 100:1 to 1:4 and more preferably 10:1 to 1:1, wherein the particle size of the alkali metal chlorides is less than 200μ, 0.5 to 5% by weight of a water soluble chloride or sulphate salt of calcium or magnesium or a mixture thereof and 0 to 10% by weight of a flavouring agent in a mixer;
ii adding 5 to 15% water by weight
iii extruding the mass obtained in step (ii) to obtain noodles; and
iv optionally subjecting the noodles to spherodisation and subsequent drying to bring the moisture to 1 to 7%.
